(19) United States
(12) Patent Application Publication
(10) Pub. No.: US 2013/0066449 A1
(43) Pub. Date: Mar. 14, 2013

(54) ATHLETE TRAINING SYSTEM

(71) Applicant: Athletes' Performance, Inc., Phoenix, AZ (US)

(72) Inventors: Mark A. Verstegen, Scottsdale, AZ (US); Daniel Craig Friedman, Tempe, AZ (US); Michael D. Michael, Bellevue, WA (US)

(73) Assignee: Athletes' Performance, Inc., Phoenix, AZ (US)

(21) Appl. No.: 13/671,606

(22) Filed: Nov. 8, 2012

Related U.S. Application Data
(63) Continuation of application No. 12/111,295, filed on Apr. 29, 2008.

(51) Int. Cl. G06F 19/00

(52) U.S. Cl. CPC G06F 19/00
USPC 700/91

(57) ABSTRACT

A system for training an athlete during a training period includes a digital system that is programmed to: receive a plurality of inputs regarding a current state of the athlete and a training goal for the athlete; employ an expert system to generate a training prescription for the athlete; and generate a plurality of control outputs that correspond to the listing of training activities. An exercise apparatus includes at least one activity device that is configured to: facilitate the athlete performing a predetermined exercise; receive the control output from the digital system and to adjust an exercise parameter so as to correspond to the training parameter indicated by the control output; and generate an electronic result output indicative of use by the athlete of the activity device wherein the result output is transmitted to the digital system.

### CROSS-REFERENCE TO RELATED APPLICATION(S)

This application is a continuation of, and claims the benefit of, U.S. patent application Ser. No. 12/111,295, filed Apr. 29, 2008, the entirety of which is hereby incorporated herein by reference.

### BACKGROUND OF THE INVENTION

1. Field of the Invention

The present invention relates to systems for training athletes and, more specifically, to a system that automates the functions of an athlete training professional.

2. Description of the Prior Art

The growth in popularity of professional and amateur sports has resulted in a substantial growth in the athletic training business. Professional athletes and premium amateur athletes (such as Olympic athletes) often hire athletic training professionals (such a strength coaches, exercise physiologists, physical therapists and the like) to prepare them for the sports in which they participate. The purpose of such preparation might be general (such as maximizing an athlete's physical condition) or it might be quite specific, for example a football receiver might come to a trainer to optimize his ability to receive a specific style of pass. It may also be directed to overcoming a specific injury or deficiency on the part of the athlete. Such training typically involves a highly specialized training and nutritional regimen based on data collected about the athlete and the considerable body of knowledge that has been accumulated in the field of sports physiology.

A typical trainer, in preparing a training regimen for an athlete, typically evaluates the current physical state of the athlete and the athlete's training goals. He then develops a training prescription for the athlete. The training prescription, which sets forth a schedule of training activities, is based on the athletes physical state and training goals in view of the trainer's knowledge of sports physiology and his experience with similar athletes. Typically, the trainer goes through an extensive thought process is developing the prescription and repeats the process before each training session with the athlete. In fact, a trainer will often spend as much as one hour preparing for a one hour training session for a professional athlete.

Such preparation and training can be quite expensive. Professional athlete-caliber trainers have a highly-specialized education and experienced trainers are in high demand. As a result, only higher tiers of athletes can afford such training There is a desire on the part of lower tier athletes for similar training, yet many such lower tier athletes simply cannot afford such training There is also a desire among professional sports teams and the like for more cost effective training of their athletes.

Therefore, there is a need for a system that automates a substantial portion of the athletic training process.

### SUMMARY OF THE INVENTION

The disadvantages of the prior art are overcome by the present invention which, in one aspect, is a system for training an athlete during a training period. The system includes a digital system that is programmed to receive a plurality of inputs regarding a current state of the athlete and a training goal for the athlete. The digital system is also programmed to employ an expert system to generate a training prescription for the athlete, wherein the expert system mimics a thought process of an athlete training professional and wherein the prescription includes a listing of training activities to be completed during each of a plurality of training sessions during the training period. The digital system is also programmed to generate a plurality of control outputs that correspond to the listing of training activities, each control output corresponding to a training activity listed in the prescription and providing an indicating of a training parameter relating to the training activity. An exercise apparatus includes at least one activity device. The activity device is configured to facilitate the athlete performing a predetermined exercise. The activity device is also configured to receive the control output from the digital system and to adjust an exercise parameter so as to correspond to the training parameter indicated by the control output. The activity device is further configured to generate an electronic result output indicative of use by the athlete of the activity device wherein the result output is transmitted to the digital system.

In another aspect, the invention is an athletic training station for training an athlete, in which an exercise apparatus is configured to facilitate performance of a plurality of exercises by the athlete. A vibration platform (such as a whole body vibration platform) is configured to generate vibrations of a preselected amplitude and a preselected frequency and is disposed in a position relative to the strength training apparatus so that the athlete is subjected to the vibrations when performing the plurality of exercises. A control circuit is coupled to the strength training apparatus and for the vibration platform and is configured to set operational parameters for the strength training apparatus and for the vibration platform in response to a predefined stimulus.

In another aspect, the invention is an exercise system for training an athlete that includes a controllable exercise apparatus that includes at least one exercise function and that is configured to set the exercise function to a selected value within a range of values in response to a control signal. A metabolic sensor is configured to sense a metabolic parameter of the athlete and to generate a metabolic signal representative thereof. A processor that is responsive to the metabolic signal is configured to compare the metabolic parameter to a preselected value. The processor is also configured to modify the control signal so that the selected value of the exercise function will cause the metabolic parameter of the athlete to tend to the preselected value. The preselected value may change during an exercise session based on input from the athlete or a coach.

In yet another aspect, the invention is a method for training an athlete, operable on a digital system that includes a memory upon which is stored a program. The athlete is queried regarding at least one goal that the athlete seeks to achieve. Data indicative of a physical state of the athlete is received. An expert system is executed on the digital system that mimics a thought process employed by a professional trainer to generate a training prescription, based on the goal and the physical state of the athlete. The prescription sets forth a schedule of when each of a plurality of exercise sessions is to occur and which exercise activities are to occur during each session. The prescription also sets forth a description of a recovery activity that is to occur as a part of each session and a nutritional activity that is to occur after each session. Data are transmitted from the digital system to an exercise apparatus so as to configure the exercise apparatus according to the prescription.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram showing various components of a training system according to one representative embodiment of the invention.

FIG. 2 is a schematic diagram showing interaction between a digital system, an exercise apparatus and components of a training facility.

FIG. 3 is a schematic diagram showing a representative strength training apparatus.

FIG. 4 is a flow diagram showing a process executed by an athlete and a training system.

FIG. 5 is a schematic diagram showing a detail of a user interface screen on one embodiment of an exercise device.

FIG. 6 is a flow diagram showing a typical training system.

FIG. 7 is a flow chart showing an athletic training system architecture.

FIG. 8 is a photograph showing a commercial embodiment of a strength training apparatus.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

The invention is a system that automates the process used to train highly accomplished athletes. It receives data regarding the athlete's conditions and goals, employs an expert system that mimics the thought process of an athlete training professional (e.g., a strength coach, an exercise physiologist, a personal coach, a physical therapist, etc.) to generate a training prescription for the athlete, and guides the athlete through a plurality of training sessions according to the prescription. The system also sets operating parameters on exercise equipment and receives data regarding the training sessions to monitor compliance with the prescription and to modify it in view of changing circumstances. Such data can relate to such parameters as: number of repetitions performed, power, speed, rate at which an action occurs, heart rate, user input and the like. The system also provides nutritional monitoring to ensure optimal results.

In one embodiment, the athlete is initially queried regarding his or her desired goals. For the example, the athlete might be training for a professional athletic league scouting combine, or he might be a professional athlete who is training to overcome a specific injury, or is just trying to stay in shape during an off-season period. The athlete might also be an amateur who is training for a specific event, such as a marathon, or the athlete might be seeking to improve general fitness.

Various biometric measurements are measured from the athlete, including such things as: height, weight, body composition (i.e., body fat, lean body mass, etc.), etc. A baseline metabolic measurement indicative of the athlete's current physical state is also taken. This might include information such as how long it takes the athlete's heart rate to recover to a first predetermined heart rate from a second predetermined heart rate and how the athlete's heart rate and respiration in respond to a variety of work loads (e.g., incline and speed on a treadmill). Based on this information and other information regarding the physical state of the athlete (including: injury history, training history, how the athlete currently fees, current state of an injury and future physical goals), the system executes a computer-based expert system that mimics the thought processes employed by a professional trainer to generate a training prescription. The expert system could be something as simple as a decision tree that is based on an expert trainer's responses to a series of questions involving the different possible goals and condition parameters of the athlete. The expert system could also be a more complicated system in which numerous case studies are put into a neural system and the neural system is programmed to converge on an optimal prescription for each set of input data regarding the current state of the athlete. As will be clearly appreciated by those of skill in the art, many other types of expert system could be employed without departing from the scope of the invention.

Based on the goal and the physical state of the athlete the expert system will generate the prescription, which sets forth a schedule of when each of a plurality of exercise sessions is to occur and which training activities are to occur during each session. The prescription will also set forth a description of the recovery activities that are to occur after each exercise or combination of exercises. The prescription will also set forth a description of the nutritional requirements of the athlete to maintain optimal results. Specifically, the system will indicate specific nutritional activities that are to occur after each session.

Periodically, either before or after each training session (or both), the system can query the athlete regarding his current physical state and current goals. This process might be something as simple as querying whether the athlete feels good or bad. The system might also ask about the degree to which an injury has healed, or whether the athlete is tired from external influences. The system might inquire about the athlete's compliance with the nutritional aspect of the training prescription while at home. Many other pieces of information about the athlete may be requested from the athlete. The system can also inquire about training activities that have been executed by the athlete away from the training facility. The system can use this information, along with performance data and metabolic data received from the exercise devices used in the training sessions to reevaluate the prescription and revise it to reflect the new information.

Once the prescription has been generated, the training period, which includes a plurality of training sessions, will commence. At each training session, the system will transmit data to the exercise apparatus that the athlete is to use to configure the exercise apparatus according to the prescription. The system may also measure performance or results of the training session.

Generally, the invention includes a system for training athletes that includes a user interface, a server that receives input from the user interface, a computer-controllable exercise machine that is coupled to the server and a software program that runs on the server. The software program receives user input and provides information regarding a training regimen to both the user and control inputs the exercise machine. The program also receives feedback from both the user and the exercise machine and makes adjustments to the training regimen based thereon.

When the athlete reports for a training session, he checks in at a check-in computer that includes a user interface, where he is asked about his current physical state. The check in can include an initial identification through, for example: the swiping of a magnetic card, the reading of a bar code card, RFID or the sensing of a near field communication chip in a cell phone, etc. The server sets several parameters of the exercise machine to levels set forth in the prescription. For example, the exercise machine may employ pneumatic dampers to provide resistance in a given exercise. The server can set the exercise machine to have a desired resistance level for the exercise by controlling the pressure in the pneumatic damper.

Once the athlete begins a training session, information about the exercises being performed may be displayed on a screen on the exercise machine. Such information can include requirements and videos showing proper performance on an exercise. The system can also provide the athlete with prompts (e.g., verbal or visual prompts) relating to the exercise.

As an exercise progresses, the exercise machine measures and records information about the athlete's progress and provides feedback to the server. The program can then adjust the prescription based on the feedback received according to the expert system being employed. The athlete indicates completion of an exercise by activating an input. Once an exercise in completed, the system starts the athlete on a next exercise. This continues until all of the scheduled exercises have been completed. Once a training session has finished, the system instructs the athlete regarding cleanup, etc. and the athlete is allowed to make a reservation for a subsequent training session. Once the athlete indicates completion of the training session, the system releases the exercise machine.

The server is in communication with the Internet so that the athlete can log on to his account remotely. For example, when the user is traveling, he may have to conduct training sessions at a hotel fitness center. In this case, the athlete can log on to the system, receive training instructions and provide information about the progress of a training session to the system. The system maintains this information in a database.

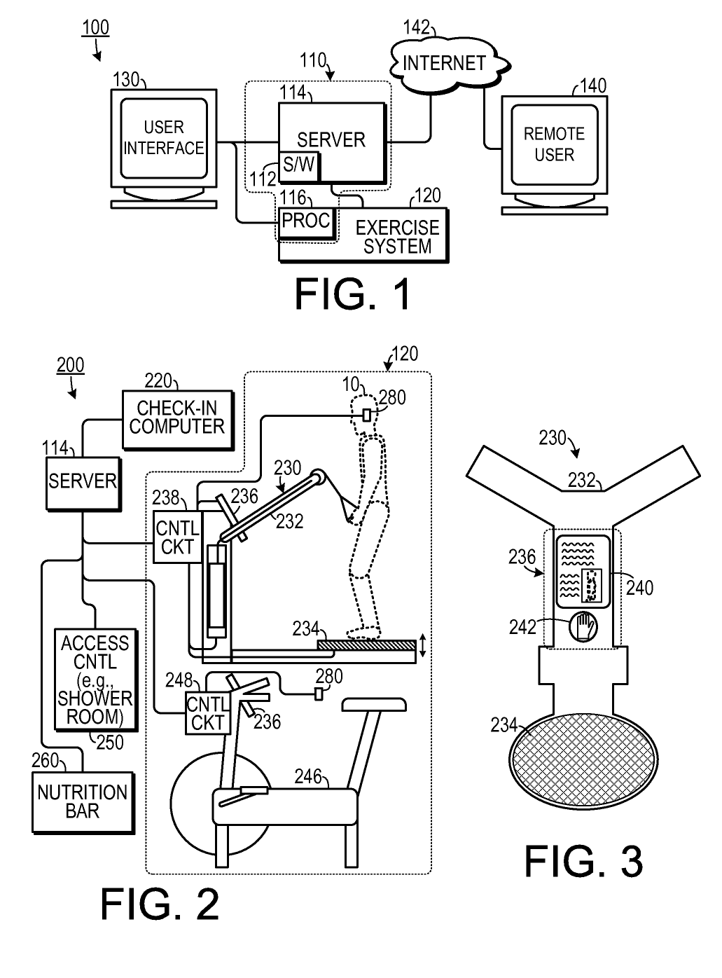

As shown in FIG. 1, in one representative embodiment, an athlete training system 100 includes a digital system 110 that runs software 112. The digital system 110 could include a central server 114, data storage and a plurality of distributed processors 116 (including, e.g., processors embedded in exercise devices) in communication with the central server 114. A user interface 130 is in data communication with the digital system 110. A remote user may communicate with the digital system 110 via a global computer network 142. An exercise system 120 communicates with the digital system.

A typical performance center 200, that would part of the athlete training system 100, is shown in FIG. 2. The server 114 is in communication with a plurality of devices, such as a touch screen and a computer 220, a plurality of exercise systems 120, an access to training-related services (such as a shower room) 250, and a nutrition bar 260. A typical exercise system 120 includes a strength training apparatus 230 (such as a resistance training apparatus well known to the art of athletic training) and an energy system development apparatus 246, such as a cardiovascular training apparatus.

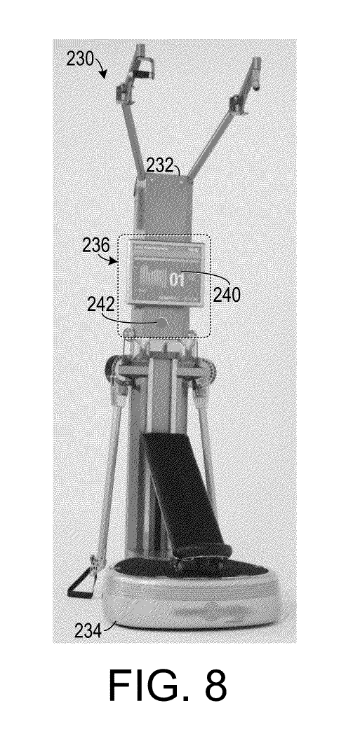

In one embodiment, as shown in FIGS. 2, 3 and 8, the strength training apparatus 230 includes an exercise machine 232 and a vibration platform 234, both of which are coupled by a control circuit 238 (which might include a local processor and associated circuitry) that is in communication with the server 114. The exercise machine 232 could be an air resistance training machine of the type known to the art of fitness training or one of many other types of strength training devices (e.g., a weight set, an elastic resistance training set, a flexible bow training set, etc.). The control circuit 238 is configured to apply resistance settings to the exercise machine 232 and to receive performance data therefrom. One type of suitable exercise machine 232 is the Infinity Functional Trainer, available from Keiser Corp., 2470 S Cherry Ave., Fresno, Calif. 93706.

The vibration platform 234 is controlled by the control circuit 238 and applies vibrations to the athlete 10 during an exercise session with the exercise machine 232. The vibrations cause increased muscle activity during the training session, added skeletal development and improved neuromuscular coordination. One type of suitable vibration platform 234 is the Power Plate, available from Power Plate North America, Inc., 400 Skokie Blvd, Suite #105, Northbrook, Ill. 60062.

The energy system development apparatus 246 could be a cardio trainer, such as an exercise bicycle, a vertical climber, an elliptical trainer or a treadmill. A control circuit 248 coupled to the energy system development apparatus 246 controls operating parameters of the apparatus 246 (such as pedal resistance in the case of an exercise bicycle, or incline and speed in the case of a treadmill, etc.). A biometric sensor 280 (such as a heart rate sensor, a respiration sensor, a galvanic skin resistance sensor, a blood pressure sensor, one of the many other types of biometric sensors known to the art, or combinations thereof) could be in communication with the control circuit 248 and provide information to the server 114 regarding the athlete's 10 current metabolic state.

The system can work as a closed loop control system (which can be designed employing well know control system design theory) by: receiving metabolic input from the biometric sensor 280, adjusting a parameter (e.g., the incline of a treadmill) of the energy system development apparatus 246 to cause the athlete's metabolic rate tend toward a preselected metabolic rate, and repeat these actions until the athlete's metabolic rate is stable within a target range of metabolic rates.

As an illustrative example, if the athlete is on a treadmill and the prescription calls for a sustained heart rate in the range of 162 to 168 beats per minute for a given period of time and if the athletes heart rate is 135 beats per minute, then the system can increase the incline of the treadmill by five degrees and increase the speed. If, in response, the heart rate levels off at 170 beats per minute, the system can reduce the incline by three degrees and decrease the speed. If the resultant heart rate then levels off at 160 beats per minute, the system could increase the incline by one degree. If the heart rate levels off at 165 beats per minute, then the system would maintain the incline for the reminder of this portion of the training session in which the heart rate stays within the desired range.

The system could also employ several different ranges for different periods. For example, the system could warm up the athlete using a target heart rate range of 110-120 beats per minute for four minutes, then increase the range to 160-170 beats per minute for four minutes, then have a wind down period where the target range is 90-100 beats per minute for another four minutes. The system could then assign a five minute rest/recovery period to the athlete, at the end of which time another exercise activity is assigned.

It is also possible to execute a closed loop system without necessarily adjusting the functionality of a device. For example, a video monitor could instruct the athlete to pedal faster (or slower) in response to his heart rate not being within the desired range. Similarly, a pace ticker (similar to a metronome) could speed up or slow down in response to a heart rate outside the desired range.

As shown in FIGS. 2 and 3, the strength training apparatus 230 has an audiovisual user interface 236 that is used to provide information to, and receive information from, the athlete 10. It is in data communication with the control circuit 238. The user interface 236 can include a video display 240 (which could include a touch screen display capable of receiving input from the athlete 10 and transmitting it to the server 114), a user input button 242 and audio speakers (not shown). The user input button 242, which in one embodiment includes an image of a palm and is called a “high five button,” is used to signal datum inputs from the athlete 10, such as an indication that the athlete 10 has completed an exercise, thereby causing the system to begin the next exercise in the prescription.

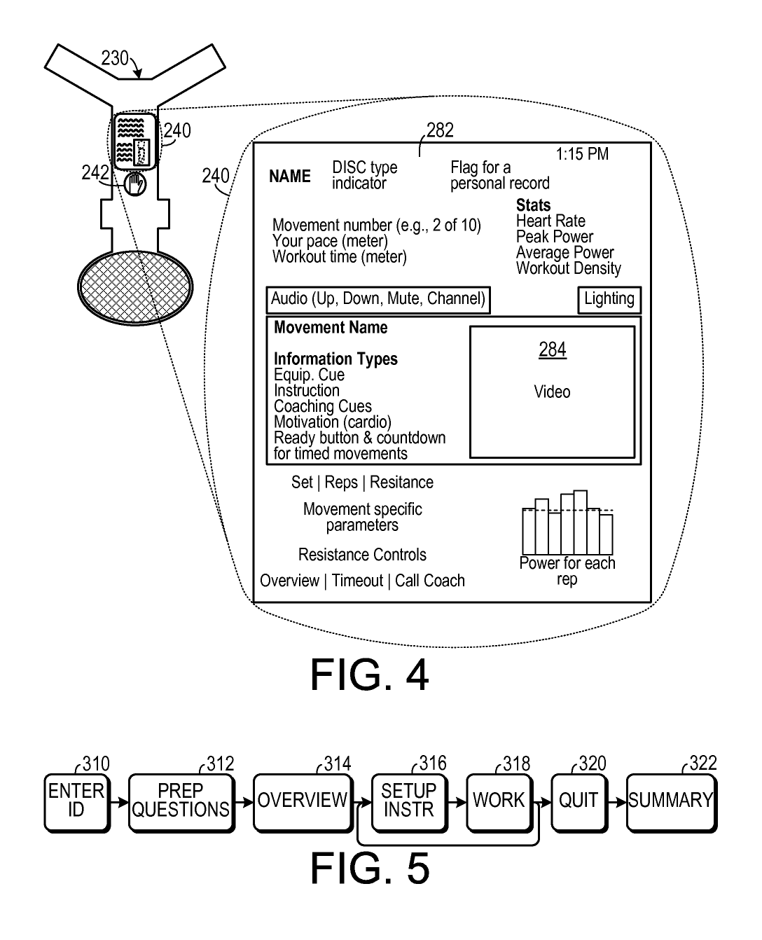

A detail of a typical screen 282 that could be shown on the video display 248 is shown in FIG. 4. This screen 282 displays information to the athlete regarding the current training activity. For example, the screen 282 could include such information as: which movement out of the total movements assigned that the athlete is currently working on, the athlete's current metabolic state, movement specific parameters and average power exerted by the athlete (including a histogram showing the power exerted in each repetition). The screen 282 can also include control inputs, such as: audio controls, lighting controls, manual resistance settings, timeout controls, a control that pages a coach, etc. The screen 282 can also include video content 284 such as a video representation or an animation of someone demonstrating the current exercise assigned to the athlete. In addition, the screen 282 can include timers, counters and other cues to help the athlete maintain cadence and correct timing for repetitive movements or timed movements. The screen 282 can also include information to assist the coach in interacting with or assisting the athlete.

The screen 282 could also be tailored to maximize communication with a specific user. For example, the screen 282 could display the athlete's name, or it could display a preferred nickname of the athlete. The system can make a personality test (such as a DISC-type test) part of the initial testing of the athlete. The resulting profile can be used to determine the optimal manner in which the screen 282 communicates with the athlete. For example, if the athlete is systems oriented, the screen 282 might display a message such as “heart rate below target: increasing incline,” whereas if the athlete is more socially oriented the screen 282 might display a message such as “John, your heart is below the target so we are going to raise the incline of your treadmill.” A coach may also adjust the communication style to reflect the needs or the preferences of the athlete.

As shown in FIG. 5, a typical athletic training session would start with the athlete entering a user identification 310 into the system. This could be done, e.g., at the check-in computer or at a remote computer by entering a personal identification number or swiping a machine-readable card. The athlete would answer several preparatory questions 312 regarding, e.g., the athlete's current state, recent activities by the athlete, the athlete's current training goals and the athlete's preferences for an after-workout nutritional supplement (e.g., the athlete's preference for flavor of a protein shake). Based on this information, the system updates the athlete's prescription, generates a revised training program for the current session and presents an overview 314 of the current session to the athlete. The system then instructs 316 the athlete on commencing the session (e.g., assigning a training apparatus to the athlete and providing the athlete with instructions on how to commence training) and the athlete commences the training session 318. The training session 318 could include several different exercises (using different exercise devices) interleaved with predetermined recovery activities. Once the training session 318 is completed, the athlete is instructed to execute a quitting protocol 320, which could include such activities as wiping down the exercise apparatus and proceeding to a nutrition bar to receive an after-workout nutritional supplement. At this stage, the system can update the athletes prescription based on data regarding the athlete's performance (including data received during the training session. The athlete is then given a summary of the training session 322 and is given access to a shower room.

The training prescription includes a nutritional component. Because of the demands of each training session on the athlete's body, the athlete will require a specific nutritional regimen to ensure that the athlete achieves optimal results. Therefore, after each training session, the athlete is given a nutritional supplement, such as a protein shake. The system inquires from the athlete about his preferred flavor at the beginning of each session and transmits this information to the nutrition bar. When the system senses the end of a training session, the system instructs the nutrition bar to prepare the nutritional supplement according to the athlete's preferences and instructs the athlete to go to the nutrition bar. Other nutritional information may be given to the athlete regarding meals taken away from the training facility. This information can include a listing of specific nutritional requirements that need to be met by the athlete at specific times during the training period to achieve optimal results. The nutritional information can provide a complete nutritional plan, including meal plans, supplementation (vitamins, minerals, etc.) and individual nutritional supplements (such as protein shakes, etc.).

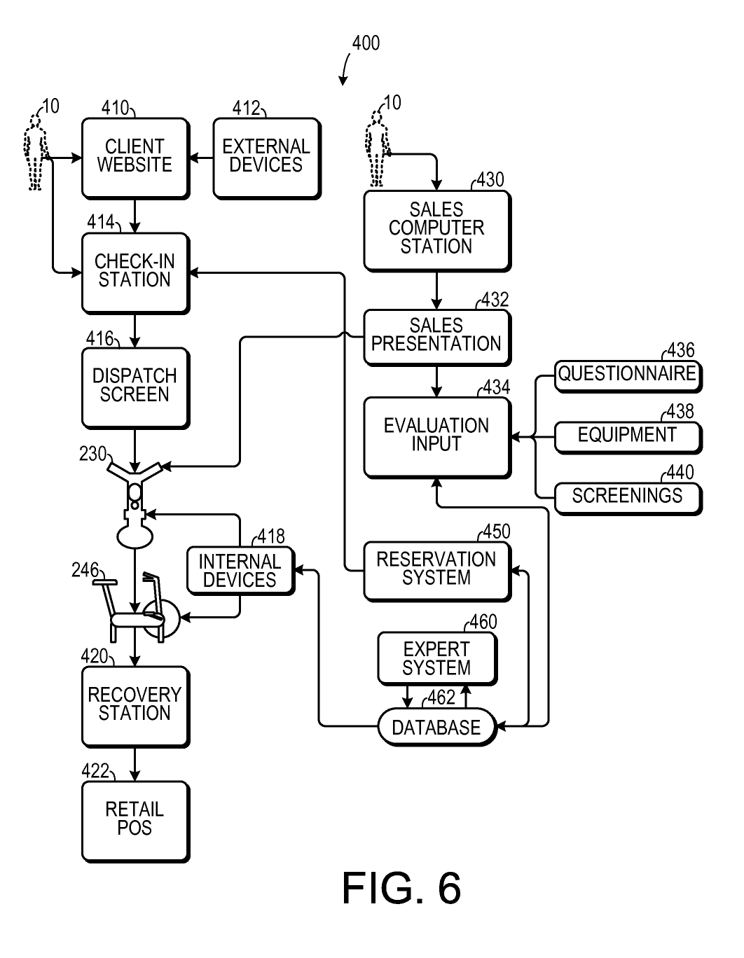

One embodiment of a training system 400 is shown in FIG. 6, in which the athlete 10 can interact with the system 400 through a remote Web site 410, a check-in computer 414 or a sales computer station 430. When an athlete 10 is using the system for the first time, he would access the sales computer station 430 and then would be given a sales presentation 432, which could be viewed on one of the exercise devices 230. The athlete 10 would the undergo an evaluation input session 434 in which he answered a baseline questionnaire 436, demonstrated his current physical state using exercise equipment 438 and was screened 440 for such things as height, weight, body composition, etc. The information acquired through the evaluation input session 434 is saved in a database 462 and used as input for the expert system engine 460. The expert system 460 then generates the prescription and stores it in the database 462.

The athlete may then use a computer-based reservation system 450 to make an appointment for one or more training sessions. This information is then transmitted to the check-in computer 414.

When the athlete 10 arrives for a training session, he identifies himself to the check-in computer 414. The system verifies his reservation and then directs him to the first exercise device 230 (e.g., a strength training device) via a dispatch display screen 416 at the check-in computer 414. The system then looks up the prescription and sets the internal control device 418 for the first exercise machine to the settings prescribed for the particular training session. The system also transmits audiovisual content to the user interface of the first exercise device 230. While the athlete 10 is training on the first exercise device 230, the system acquires data about the athlete's performance and transmits it to the database 462.

Once the athlete has completed the first portion of a training session on the first exercise device 230, the system will instruct him to begin a training portion of the second exercise device 246 (e.g., an energy system training device). Once that portion of the session is complete, the athlete 10 will be directed to a recovery station 420 where he is debriefed about the session and given a nutritional component required by the prescription. He may then be directed to a retail point of sale 422 to pay for the session. The athlete might use another payment method, such as prepayment for a number of sessions and subscription for a given period of time.

The athlete 10 can access the prescription while away from the training facility 410 using a client Web site 410. Thus, he can exercise on external devices 412 and report the results via the client Web site 410.

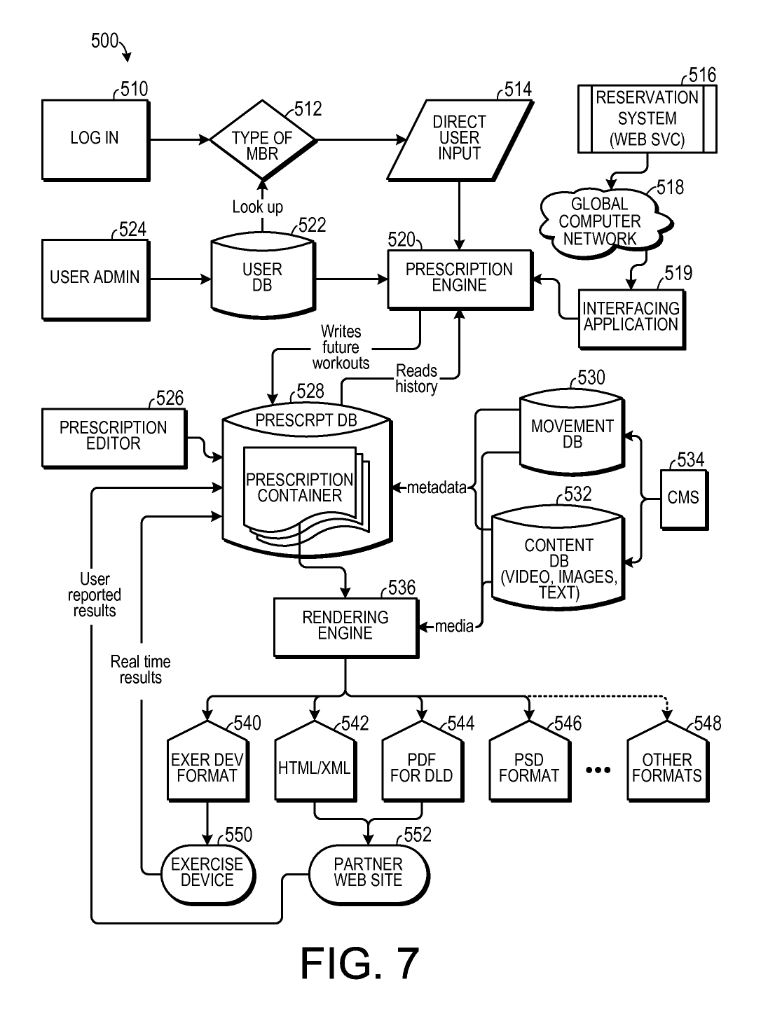

In one embodiment, as shown in FIG. 7, the architecture 512 of the digital system includes a log in routine 510, whose input queries a database 522 of the system's users to indicate the type of member 512 to the system. The athlete can maintain parts of his profile in the user database 522 via a user administration function 524. The athlete can also provide other direct input 514 to the system. This input, along with input from a reservation system 516 from a computer network 518 (via an interfacing application 519) can be fed into the prescription engine 520, which generates and revises the prescription.

The prescription engine 520 creates the prescription based on business logic integrating the various data points collected by the other entities. The parameters used by the business logic include: the athlete's goal (acquired from the interview in the athlete profile); the most recent functional movement screen test; the achievement of past prescriptions (based on percent of peak power); the athlete's past attendance record; the athlete's current state(s) in activity progression(s) from the user database 522; the athlete's the response to a current “how do you feel?”-type question; the athlete's multi-day training plan with the location of the equipment used (e.g., on-site or off-site) for each day; and the amount of time the athlete currently has available for the present training session.

The prescription is stored in a prescription database 528, and can also be edited directly by a supervisory professional trainer via a prescription editor 526. The prescription database 528 holds the prescription information for each athlete in the system, including prescriptions created for future use and the results of past performance. The prescription database 528 also includes one or more prescription containers, which maintain all the pieces of the prescription and which control delivery of the information to a rendering engine 536.

The rendering engine 536, receives input from the prescription container, a movement database 530 and a content database 532. The movement database 530 stores all of the movements that can be part of a training prescription, matched with equipment resources that match location of workout (e.g., training facility, home, gym, hotel, etc.). The content database 532 stores video and metadata that accompanies each movement. Each of these databases may be driven by the content management system (CMS) 534. The rendering engine 536 creates presentation layer according to specific output and will drive both the exercise equipment in the training facility and the remote website (when it is being used by the athlete while away from the training facility).

The rendering engine 536 will generate output in several different formats, including: (1) the format 540 required by the exercise devices 550 at the training facility; an HTML or XML format 542 for transmission to a partner Web site 552; a portable document format (PDF) 544 for remote downloading by the athlete; a personal storage device format 546 (e.g., the iPOD format) for use by the athlete while traveling; and any other format 548 that could be needed by the athlete.

In one embodiment, the system could embed sensors, such as accelerometers, in pieces of exercise equipment to collect data about the exact movements of the athlete. The system could also use sensors to determine exactly which weight settings an athlete applies to a weight training machine to ensure compliance with the prescription. Embedded sensors (along with wireless transmitters) could be used with dumbbells, barbells and other exercise implements.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A system for training an athlete during a training period, comprising:
(a) a digital system programmed to:
(i) receive a plurality of inputs regarding the athlete, including a baseline metabolic measurement of the athlete, information regarding a current physical state of the athlete and a training goal for the athlete;
(ii) employ an expert system to generate a training prescription for the athlete, wherein the expert system mimics a thought process of an athlete training professional to generate the training prescription so that the prescription is based on the baseline metabolic measurement of the athlete, the current physical state of the athlete and the training goal of the athlete and wherein the prescription sets forth a schedule of when each of a plurality of training sessions is to occur, the prescription also setting forth a listing of training activities to be completed during each of a plurality of training sessions during a training period, the listing of training activities including: a plurality of different exercises to be performed during each session; at least one recovery activity to be performed after each exercise; and a nutritional activity to be performed after each training session; and
(iii) generate a plurality of control outputs that correspond to the listing of training activities, each control output corresponding to a training activity listed in the prescription and providing an indication of a training parameter relating to the training activity; and
(b) an exercise apparatus that includes at least one activity device, the activity device configured to facilitate the athlete performing a predetermined exercise, the activity device configured to receive each control output from the digital system and to adjust an exercise parameter so as to correspond to the training parameter indicated by each control output, the activity device configured to generate an electronic result output indicative of use by the athlete of the activity device wherein the result output is transmitted to the digital system.

2. The system of claim 1, wherein the exercise apparatus includes at least one sensor that is configured to measure a performance of the athlete and wherein the digital system is responsive to the sensor and wherein the digital system is further configured to modify the prescription based on the performance of the athlete measured by the sensor.

3. The system of claim 2, wherein the performance of the athlete comprises a measurement selected from a group consisting of: a metabolic state of the athlete; a power level exerted by the athlete; an energy level expended by the athlete and combinations thereof.

4. The system of claim 3, wherein the digital system is configured to modify an operational parameter of the exercise apparatus so as to cause the metabolic state of the athlete to tend toward a preselected target metabolic state.

5. The system of claim 1, wherein the digital system is configured as a server that is coupled to a plurality of different exercise apparatuses.

6. The system of claim 1, wherein the digital system is further programmed to:
(a) sense an end of a training session;
(b) instruct a nutrition bar to prepare the nutritional supplement; and
(c) instruct the athlete to go to the nutrition bar

7. The system of claim 1, wherein the plurality of inputs regarding a current state of the athlete comprises physical data indicative of a physical state of the athlete.

8. The system of claim 7, wherein the physical data comprises data selected from a list consisting of: results of measurements of a performance by the athlete of at least one physical task; at least one measured physical parameter that describes at least one attribute of the athlete's physique; and combinations thereof.

9. The system of claim 1, wherein the digital system is programmed to query the athlete regarding a new physical state of the athlete before at least one of the training sessions and wherein the digital system is further configured to modify the prescription based on the new physical state.

10. The system of claim 1, wherein the digital system is coupled to a global computer network and is configured to receive input from a remote station indicative of training activities performed by the athlete while the athlete is away from the exercise apparatus.

11. The system of claim 1, wherein the exercise apparatus comprises a selected one of a strength training apparatus or an energy system development apparatus.

12. A method for training an athlete, operable on a digital system that includes a memory upon which is stored a program, the method comprising the actions of:
(a) querying the athlete regarding at least one goal that the athlete seeks to achieve;
(b) receiving data indicative of a physical state of the athlete, including a baseline metabolic measurement of the athlete and information regarding a current physical state of the athlete; and
(c) executing an expert system on the digital system that mimics a thought process employed by an athletic training professional to generate a training prescription, based on the goal and the physical state of the athlete, the prescription setting forth a schedule of when each of a plurality of exercise sessions is to occur and which exercise activities are to occur during each session, the prescription also setting forth a description of a recovery activity that is to occur as a part of each session and a nutritional activity that is to occur after each session.

13. The method of claim 12, further comprising the action of transmitting data from the digital system to at least one electronically configurable exercise apparatus so as to configure the exercise apparatus according to the prescription and also to at least one electronically configurable vibration platform so as to configure the vibration platform according to the prescription.

14. The method of claim 13, wherein the training activities include a plurality of exercises, each of which is to occur at a time determined by the expert system.

15. The method of claim 12, further comprising the actions of:
(a) receiving data indicative of a revised physical state of the athlete after completion of one of the exercise sessions; and
(b) executing the expert system so as to revise the prescription based on the revised physical state.

16. The method of claim 12, further comprising the actions of:
(a) receiving data from the athletic training station regarding performance by the athlete; and
(b) executing the expert system so as to revise the prescription based on the data received from the athletic training station.

17. The method of claim 12, further comprising the action of transmitting instructional information to an athletic training station, the instructional information relating to an exercise that is part of the training prescription.

18. The method of claim 12, wherein the data regarding a current physical state of the athlete includes data regarding a physical condition of the athlete.

19. The method of claim 12, wherein the data regarding a current physical state of the athlete includes data regarding a measured performance metric relative to the athlete.

20. The method of claim 12, further comprising the actions of:
(a) receiving an identification of the athlete;
(b) directing the athlete to a specific athletic training station; and
(c) configuring the specific athletic training station according to the training prescription corresponding to the athlete.
